(19) United States
(12) Patent Application Publication
(10) Pub. No.: US 2025/0218398 A1
(43) Pub. Date: Jul. 3, 2025

(54) DISPLAY DEVICE AND DRIVING METHOD OF THE SAME

(71) Applicant: LG Display Co., Ltd., Seoul (KR)

(72) Inventors: Jin Woo LEE, Paju-si (KR); Hee Young CHAE, Paju-si (KR)

(73) Assignee: LG Display Co., Ltd., Seoul (KR)

(21) Appl. No.: 18/976,653

(22) Filed: Dec. 11, 2024

(30) Foreign Application Priority Data
Dec. 29, 2023 (KR) 10-2023-0197859

(51) Int. Cl. G09G 3/3275; G09G 3/20

(52) U.S. Cl. CPC G09G 3/3275; G09G 3/2003; G09G 3/2074; G09G 2310/08

(57) ABSTRACT

A display device can include a display panel having pixel groups configured to emit light to display an image, a data driver configured to drive the display panel, and a timing controller configured to control the data driver. At least one of the pixel groups includes a normal subpixel connected to a data line and a compensation subpixel connected to the data line and a sensing line. The normal subpixel and the compensation subpixel emit light of different colors.

### CROSS-REFERENCE TO RELATED APPLICATIONS

This application claims priority to Korean Patent Application No. 10-2023-0197859, filed in the Republic of Korea on Dec. 29, 2023, the entire contents of which is hereby expressly incorporated by reference into the present application.

### BACKGROUND

### Field

The present disclosure relates to a display device and a driving method of the same.

### Discussion of the Related Art

With the development of information technology, a market for display devices that are used in connection between users and information has been growing. Accordingly, display devices such as a light-emitting display (LED) device, a quantum dot display (QDD), and a liquid crystal display (LCD) have been increasingly used.

Each of such display devices includes a display panel including subpixels, a driver configured to output a driving signal for driving of the display panel, and a power supply configured to generate power to be supplied to the display panel or the driver.

In such a display device, when driving signals, for example, scan signals and data signals, are supplied to the subpixels formed in the display panel, a selected one of the subpixels can transmit light therethrough or can directly emit light, thereby displaying an image.

### SUMMARY OF THE DISCLOSURE

Accordingly, the present disclosure is directed to a display device and a method of driving the same that substantially obviate one or more problems due to limitations and disadvantages of the related art.

The present disclosure improves correction accuracy and compensation performance by compensating for a normal subpixel for emitting the same color in a surrounding area based on a sensing value and accumulated stress (e.g., usage) and correcting (reestablishing) and updating a sensing-less compensation algorithm based on a sensing value of a compensation subpixel.

Additional advantages, objects, and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description and claims hereof as well as the appended drawings.

To achieve these objects and other advantages and in accordance with the purpose of the disclosure, as embodied and broadly described herein, a display device includes a display panel including pixel groups configured to emit light to display an image, a data driver configured to drive the display panel, and a timing controller configured to control the data driver, wherein at least one of the pixel groups includes a normal subpixel connected to a data line and a compensation subpixel connected to the data line and a sensing line, and the normal subpixel and the compensation subpixel emit light of different colors.

According to aspects of the present disclosure, the pixel groups can include at least four pixel groups each including a compensation subpixel configured to emit a different color.

According to aspects of the present disclosure, the at least four pixel groups can all be disposed on one gate line defined in the display panel or can be disposed one by one for each gate line defined in the display panel.

According to aspects of the present disclosure, the at least four pixel groups can include a first pixel group including a compensation subpixel configured to emit a first color, a second pixel group including a compensation subpixel configured to emit a second color different from the first color, a third pixel group including a compensation subpixel configured to emit a third color different from the second color, and a fourth pixel group including a compensation subpixel configured to emit a fourth color different from the third color.

According to aspects the present disclosure, the first pixel group can include a first subpixel connected to a first data line and a first sensing line, a second subpixel connected to a second data line adjacent to the first data line, a third subpixel connected to a third data line spaced apart from the second data line, and a fourth subpixel connected to a fourth data line adjacent to the third data line, and the second pixel group can include a fifth subpixel connected to a fifth data line, a sixth subpixel connected to a sixth data line adjacent to the fifth data line, a seventh subpixel connected to a seventh data line spaced apart from the sixth data line and a second sensing line, and an eighth subpixel connected to an eighth data line adjacent to the seventh data line.

According to aspects of the present disclosure, the data driver can provide a sensing value acquired from the compensation subpixel to the timing controller, and the timing controller can compensate for deterioration of at least one of the normal subpixel or the compensation subpixel based on the sensing value provided from the data driver.

According to aspects of the present disclosure, the timing controller can correct a lookup table of a compensation algorithm prepared to compensate for deterioration of at least one of the normal subpixel or the compensation subpixel based on the sensing value.

In another aspect of the present disclosure, a display device includes a display panel including at least four pixel groups each including one compensation subpixel configured to emit light of a different color, a data driver configured to drive the display panel and sense each of the at least four pixel groups to acquire each of color-specific sensing values having color representativeness from the compensation subpixel, and a timing controller configured to control the data driver and compensate for data signals to be supplied to normal subpixels included in the at least four pixel groups based on the color-specific sensing values.

According to aspects of the present disclosure, the timing controller can compensate for a normal subpixel configured to emit light of the same color as the color of the compensation subpixel based on the color-specific sensing values.

According to aspects of the present disclosure, the at least four pixel groups can include a first pixel group including a compensation subpixel configured to emit light of a first color and three normal subpixels, a second pixel group including a compensation subpixel configured to emit light of a second color different from the first color and three normal subpixels, a third pixel group including a compensation subpixel configured to emit light of a third color different from the second color and three normal subpixels, and a fourth pixel group including a compensation subpixel configured to emit light of a fourth color different from the third color and three normal subpixels.

In another aspect of the present disclosure, a driving method of a display device includes driving at least four pixel groups each including one compensation subpixel configured to emit light of a different color, sensing each of the at least four pixel groups to acquire each of color-specific sensing values having color representativeness from the compensation subpixel, and compensating for data signals to be supplied to normal subpixels included in the at least four pixel groups based on the color-specific sensing values.

According to aspects of the present disclosure, the compensating can include compensating for a normal subpixel configured to emit the same color of the color of the compensation subpixel based on the color-specific sensing values.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating an LED device, FIGS. 2 and 3 are diagrams for describing a configuration of a gate-in-panel (GIP)-type scan driver, and FIG. 4 is a module configuration diagram of the LED device;

FIG. 5 is a subpixel configuration diagram of the display panel, FIG. 6 is an illustrative circuit configuration diagram of a normal subpixel, FIG. 7 is an illustrative circuit configuration diagram of a compensation subpixel, and FIG. 8 is a diagram for briefly describing a configuration of a data driver connected to the compensation subpixel;

FIG. 9 is an illustrative diagram illustrating pixel groups according to a first embodiment of the present disclosure, and FIGS. 10 and 11 are diagrams for briefly describing a compensation method using subpixels included in a pixel group according to the first embodiment;

FIG. 12 is a flowchart for describing a compensation method according to the first embodiment, FIG. 13 is a reference diagram illustrating an example of a process of expanding a search range in step S40 according to the first embodiment, and FIG. 14 is a reference diagram illustrating an example in which a sensing value of a compensation subpixel is reflected in a normal subpixel according to the first embodiment;

FIG. 15 is an illustrative diagram illustrating pixel groups according to a second embodiment of the present disclosure, FIG. 16 is a first illustrative arrangement diagram of a display panel prepared based on the pixel groups illustrated in FIG. 15, and FIG. 17 is a second illustrative arrangement diagram of a display panel prepared based on the pixel groups illustrated in FIG. 15;

FIG. 18 is an illustrative diagram illustrating pixel groups according to a third embodiment of the present disclosure, FIG. 19 is a first illustrative arrangement diagram of a display panel prepared based on the pixel groups illustrated in FIG. 18, and FIG. 20 is a second illustrative arrangement diagram of a display panel prepared based on the pixel groups illustrated in FIG. 18; and

FIG. 21 is an illustrative arrangement diagram of a display panel prepared based on pixel groups according to a fourth embodiment of the present disclosure, and FIG. 22 is a flowchart for describing a compensation method according to the fourth embodiment.

### DETAILED DESCRIPTION OF THE EMBODIMENTS

Reference will now be made in detail to the example embodiments of the present disclosure, examples of which are illustrated in the accompanying drawings. Wherever possible, the same reference numbers will be used throughout the drawings to refer to the same or like parts. Further, the term “can” fully encompasses all the meanings and coverages of the term “may.”

A display device according to the present disclosure can be implemented as a television, a video player, a personal computer (PC), a home theater, an automotive electric device, or a smartphone, but is not limited thereto. The display device according to the present disclosure can be implemented as an LED device, a QDD, or an LCD. For convenience of description, an LED device that directly emits light based on an inorganic light-emitting diode or an organic light-emitting diode will hereinafter be taken as an example.

In addition, a thin film transistor (TFT) described below can be implemented as an n-type TFT, as a p-type TFT, or in a form in which n-type and p-type are present together. The TFT is a three-electrode element including a gate, a source, and a drain. The source is an electrode that supplies a carrier to a transistor. In the TFT, a carrier starts flowing from the source. The drain is an electrode through which a carrier exits the TFT. For example, in the TFT, a carrier flows from the source to the drain.

In the case of the p-type TFT, since the carrier is a hole, a source voltage is higher than a drain voltage so that the hole can flow from the source to the drain. In the p-type TFT, a hole flows from the source to the drain side, and thus current flows from the source to the drain side. In contrast, in the case of the n-type TFT, since an electron is a carrier, the source voltage is lower than the drain voltage so that an electron can flow from the source to the drain. In the n-type TFT, an electron flows from the source to the drain side, and thus current flows from the drain to the source side. However, the source and the drain of the TFT can be changed depending on the applied voltage. Reflecting this, in the following description, one of the source and drain will be described as a first electrode, and the other of the source and drain will be described as a second electrode.

All the components of each display device according to all embodiments of the present disclosure are operatively coupled and configured.

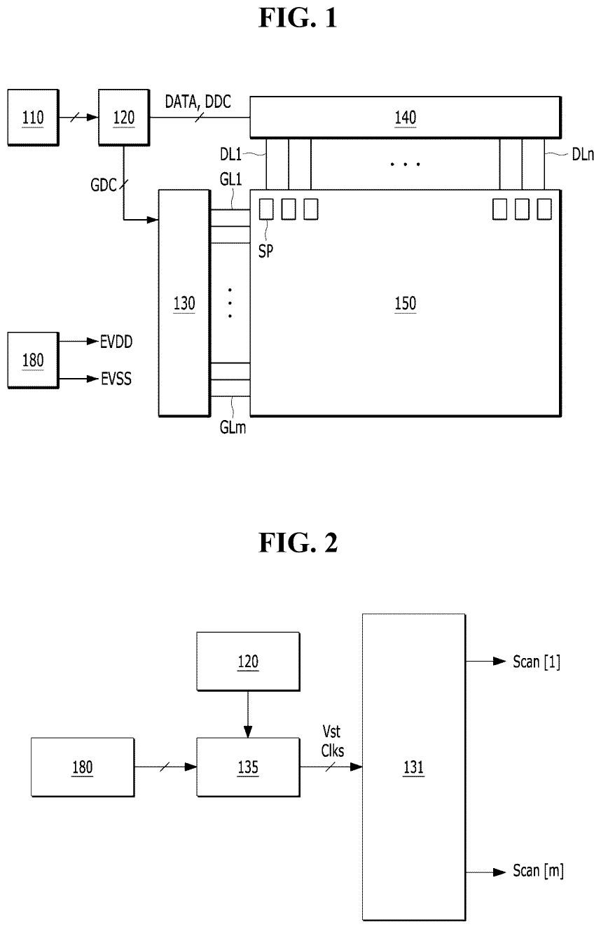

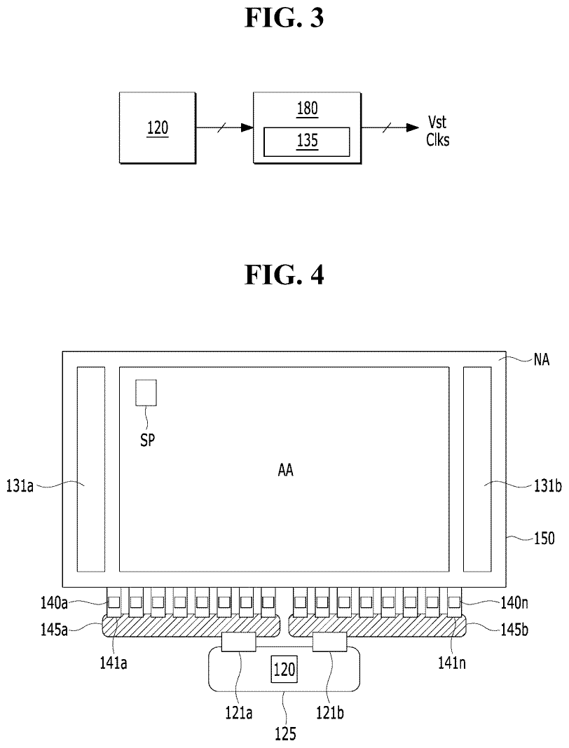

FIG. 1 is a block diagram schematically illustrating an

FIGS. 2 are diagrams for describing LED device, and 3 a configuration of a GIP-type scan driver, and FIG. 4 is a module configuration diagram of the LED device.

As illustrated in FIG. 1, the LED device can include an image supply 110, a timing controller 120, a scan driver 130, a data driver 140, a display panel 150, a power supply 180, etc.

The image supply (set or host system) 110 can output various driving signals together with an externally-supplied image data signal or an image data signal stored in an internal memory. The image supply 110 can supply the data signal and the various driving signals to the timing controller 120.

The timing controller 120 can output a gate timing control signal GDC for control of operation timing of the scan driver 130, a data timing control signal DDC for control of operation timing of the data driver 140, various synchronization signals (a vertical synchronization signal Vsync and a horizontal synchronization signal Hsync), etc. The timing controller 120 can supply a data signal DATA supplied from the image supply 110 together with the data timing control signal DDC to the data driver 140. The timing controller 120 can take the form of an integrated circuit (IC) and be mounted on a printed circuit board, but is not limited thereto.

The scan driver 130 can output a scan signal (or scan voltage) in response to the gate timing control signal GDC supplied from the timing controller 120. The scan driver 130 can supply the scan signal to each of subpixels included in the display panel 150 through gate lines GL1 to GLm, where m is a real number. The scan driver 130 can take the form of an IC or can be formed directly on the display panel 150 in a GIP manner, but is not limited thereto.

The data driver 140 can sample and latch the data signal DATA in response to the data timing control signal DDC supplied from the timing controller 120, convert the resulting digital data signal into an analog data voltage based on a gamma reference voltage, and output the converted analog data voltage. The data driver 140 can supply data voltages to the subpixels included in the display panel 150 through data lines DL1 to DLn, where n is a real number. The data driver 140 can take the form of an IC and be mounted on the display panel 150 or on the printed circuit board, but is not limited thereto.

The power supply 180 can generate a high-potential voltage and a low-potential voltage based on an external input voltage supplied from the outside and output the high-potential voltage and the low-potential voltage through a high-potential voltage line EVDD and a low-potential voltage line EVSS. The power supply 180 can generate and output not only the high-potential voltage and the low-potential voltage, but also a voltage (for example, a gate high voltage and a gate low voltage) required to drive the scan driver 130 or a voltage (for example, a drain voltage and a half drain voltage) required to drive the data driver 140.

The display panel 150 can be manufactured based on a rigid or flexible substrate of glass, silicon, polyimide, etc. The display panel 150 can include a plurality of subpixels SP for displaying an image based on a scan signal, a driving signal including a data voltage, a high-potential voltage, a low-potential voltage, etc. The subpixels SP can be connected to the first data line DL1, the first gate line GL1, the high-potential voltage line EVDD, and the low-potential voltage line EVSS. The subpixels SP can directly emit light. The subpixel SP can emit light of one of colors of red, green, blue, white, etc.

Meanwhile, the timing controller 120, the scan driver 130, the data driver 140, etc., have been described above as having individual configurations. However, one or more of the timing controller 120, the scan driver 130, and the data driver 140 can be integrated into one IC depending on the implementation scheme of the LED device.

As illustrated in FIGS. 2 and 3, the GIP-type scan driver can include a shift register 131 and a level shifter 135. The level shifter 135 can generate scan clock signals Clks, a start signal Vst, etc. based on signals and voltages output from the timing controller 120 and the power supply 180.

The shift register 131 can operate based on signals Clks and Vst, etc. output from the level shifter 135, and output scan signals Scan[1] to Scan[m] capable of turning on or turning off a transistor formed in the display panel. The shift register 131 can take the form of a thin film on the display panel using a GIP method.

Unlike the shift register 131, the level shifter 135 can independently take the form of an IC or be included in the power supply 180. However, this is only an example and the present disclosure is not limited thereto.

As illustrated in FIG. 4, the display panel 150 can include an active area AA (or display area) in which an image is displayed and a non-active area NA (or non-display area) in which no image is displayed. The non-active area NA can surround the active area AA entirely or only in part(s). The subpixels SP can be located in the display area AA. Shift registers 131a and 131b configured to output scan signals in the GIP-type scan driver can be located in the non-active area NA.

The display panel 150 can be configured as a module by a plurality of data drivers 140a to 140n mounted on a plurality of first circuit boards 141a to 141n and one timing controller 120 mounted on one control board 125. The plurality of data drivers 140a to 140n and the one timing controller 120 can be electrically connected by at least two second circuit boards 145a to 145b, at least two cables 121a to 121b, etc. Flexible circuit boards can be selected as the plurality of first circuit boards 141a to 141n, and printed circuit boards can be selected as the at least two second circuit boards 145a to 145b. However, the module configuration diagram illustrated in FIG. 4 is only to aid understanding, and the present disclosure is not limited thereto.

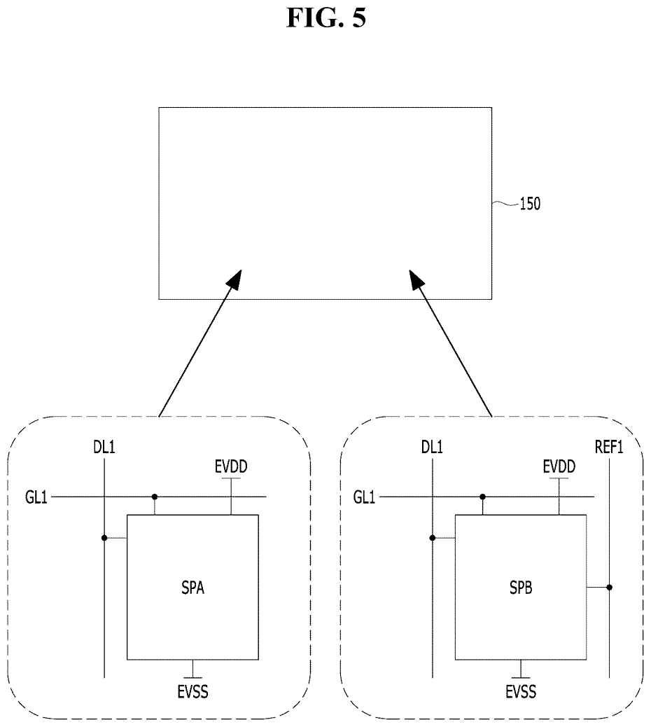

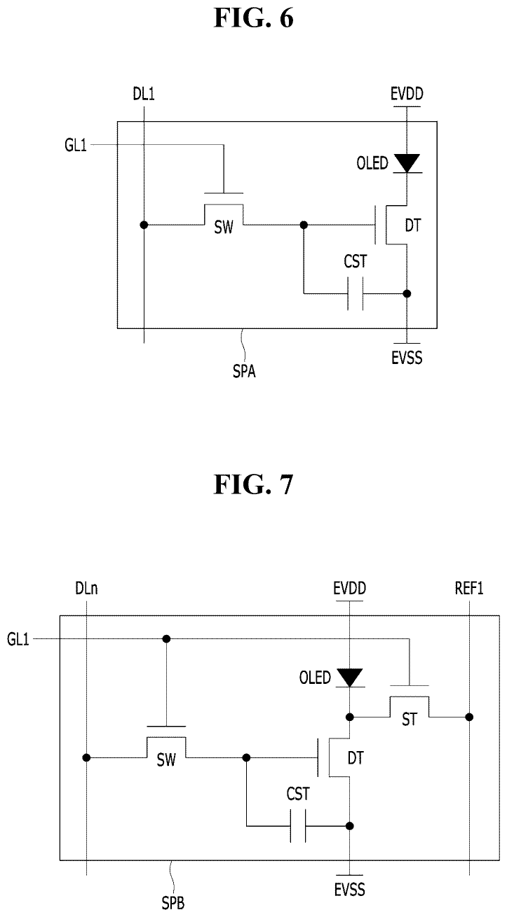

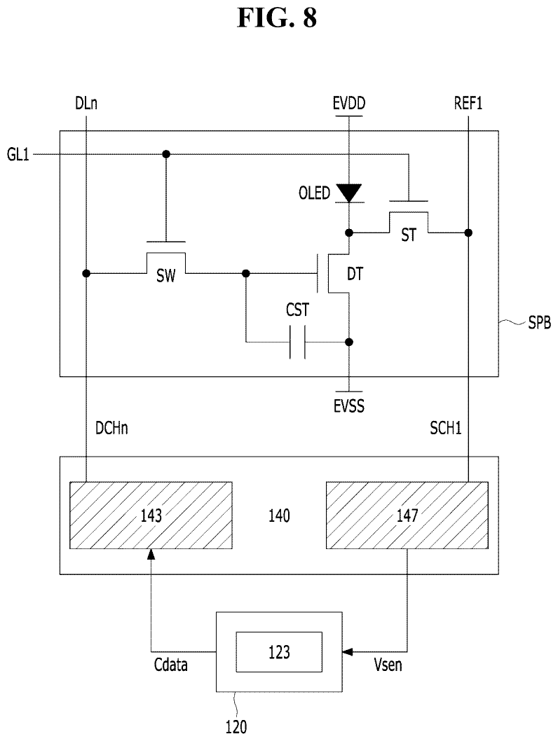

FIG. 5 is a subpixel configuration diagram of the display panel, FIG. 6 is an illustrative circuit configuration diagram of a normal subpixel, FIG. 7 is an illustrative circuit configuration diagram of a compensation subpixel, and FIG. 8 is a diagram for briefly describing a configuration of a data driver connected to the compensation subpixel.

As illustrated in FIG. 5, the display panel 150 can be implemented as a hybrid type including a combination of a normal subpixel (non-sensing subpixel) SPA and a compensation subpixel (sensing subpixel) SPB. The normal subpixel SPA can be connected to the first gate line GL1, the first data line DL1, the high-potential voltage line EVDD, and the low-potential voltage line EVSS. The compensation subpixel SPB can be connected to the first gate line GL1, the first data line DL1, a first sensing line REF1, the high-potential voltage line EVDD, and the low-potential voltage line EVSS. The first sensing line REF1 can be used to sense electrical characteristics (threshold voltage, mobility, etc.) of element(s) included in the compensation subpixel SPB, which is covered below.

As illustrated in FIG. 6, the normal subpixel SPA can include a switching transistor SW, a capacitor CST, a driving transistor DT, and an organic light-emitting diode OLED.

The switching transistor SW can serve to transmit a data voltage applied through the first data line DLI to a first electrode of the capacitor CST. The capacitor CST can serve to store a data voltage for driving the driving transistor DT. The driving transistor DT can serve to generate a driving current in response to the data voltage stored in the capacitor CST. The organic light-emitting diode OLED can serve to emit light in response to an operation (driving current) of the driving transistor DT.

Without directly sensing an element causing deterioration, the normal subpixel SPA can use a sensing-less compensation method for predicting (accumulating the amount of stress to usage and predicting deterioration of an element based thereon) and compensating for a degree of deterioration based on a data counting method, a modeling method prepared based on usage time, etc. However, since the sensing-less compensation method does not directly sense the element causing deterioration, there can be difficulties in precise compensation.

As illustrated in FIG. 7, the compensation subpixel SPB can include a switching transistor SW, a capacitor CST, a driving transistor DT, a sensing transistor ST, and an organic light-emitting diode OLED.

The organic light-emitting diode OLED can have an anode connected to the high-potential voltage line EVDD and a cathode connected to a first electrode of the driving transistor DT. The driving transistor DT can have a gate electrode connected to a first electrode of the capacitor CST, the first electrode connected to the cathode of the organic light-emitting diode OLED, and a second electrode connected to the low-potential voltage line EVSS.

The capacitor CST can have the first electrode connected to the gate electrode of the driving transistor DT and a second electrode connected to the second electrode of the driving transistor DT and the low-potential voltage line EVSS.

The switching transistor SW can have a gate electrode connected to the first gate line GL1, a first electrode connected to the Nth data line DLn, and a second electrode connected to the gate electrode of the driving transistor DT. The sensing transistor ST can have a gate electrode connected to the first gate line GL1, a first electrode connected to the first sensing line REF1, and a second electrode connected to the cathode of the organic light-emitting diode OLED and the first electrode of the driving transistor DT corresponding to a sensing node.

The compensation subpixel SPB can use a sensing-type compensation method to determine and compensate for a degree of deterioration based on a circuit inside the subpixel and an external circuit capable of directly sensing the element causing deterioration. The sensing-type compensation method is a method that can directly sense the element causing deterioration, and thus has an advantage of enabling precise compensation.

Meanwhile, the configuration of the normal subpixel SPA and the compensation subpixel SPB described above should be interpreted as an example. Hereinafter, a device for driving a hybrid of the normal subpixel SPA and the compensation subpixel SPB is understood with reference to the following description.

As illustrated in FIG. 8, the data driver 140 can include a voltage output circuit 143 configured to output a data voltage, a pixel sensing circuit 147 configured to acquire a sensing value, etc. An Nth output channel DCHn of the voltage output circuit 143 can be connected to the Nth data line DLn of the compensation subpixel SPB, and a first sensing channel SCH1 of the pixel sensing circuit 147 can be connected to the first sensing line REF1 of the compensation subpixel SPB.

The pixel sensing circuit 147 can be used to sense the presence or absence of deterioration of the driving transistor DT and the organic light-emitting diode OLED. Further, the pixel sensing circuit 147 can be used to sense the presence or absence of abnormalities in the driving transistor DT and the organic light-emitting diode OLED. Further, the pixel sensing circuit 147 can be used to sense current or voltage flowing through the driving transistor DT and the organic light-emitting diode OLED.

The data driver 140 can convert a sensing value Vsen acquired by the pixel sensing circuit 147 into a digital value and transmit the converted value to the timing controller 120 (or compensation circuit). Further, the timing controller 120 can determine whether there is a change in the characteristics (threshold voltage, mobility, etc.) of element(s) included in the compensation subpixel SPB based on the sensing value Vsen converted to a digital value, and prepare a compensation value for compensating for at least one of the compensation subpixel SPB and the normal subpixel.

Meanwhile, the timing controller 120 can use compensation value in a deterioration prediction compensator 123 to compensate for the normal subpixel in a non-sensing manner, and prepare a compensation data signal Cdata based thereon. In this case, the deterioration prediction compensator 123 modifies (reestablishes) a previously prepared deterioration prediction model in response to changes in characteristics (threshold voltage, mobility, etc.) of an actual deteriorated element(s) based on the sensing value Vsen, and thus can improve compensation accuracy and compensation performance.

In addition, the timing controller 120 can acquire driving environment variables such as changes in current, changes in voltage, and changes in temperature (a method of predicting temperature changes based on changes in current or voltage) based on the sensing value Vsen, and individually or collectively compensate for (control) the display panel and a device required to drive the display panel (for example, the data driver, the scan driver, the power supply, etc.) based thereon.

The present disclosure proposes the following pixel arrangement structure to achieve advantages in various aspects such as manufacturing, driving, and compensation when implementing a hybrid display panel including the combination of the normal subpixel and the compensation subpixel.

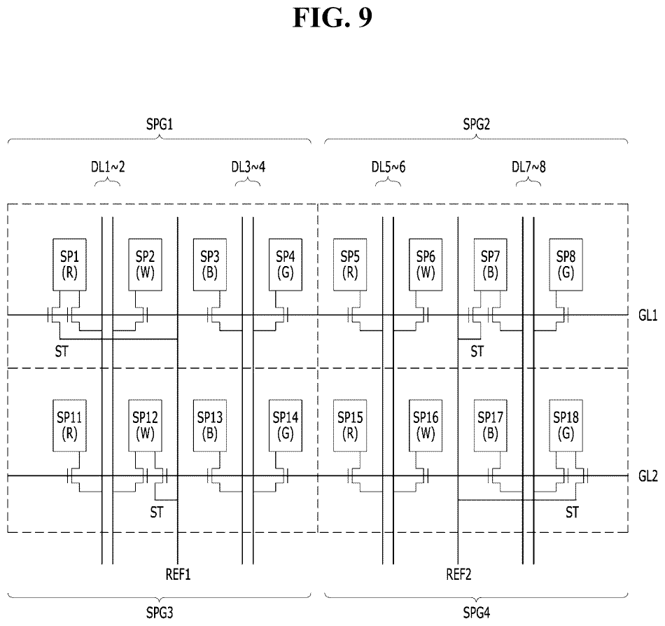

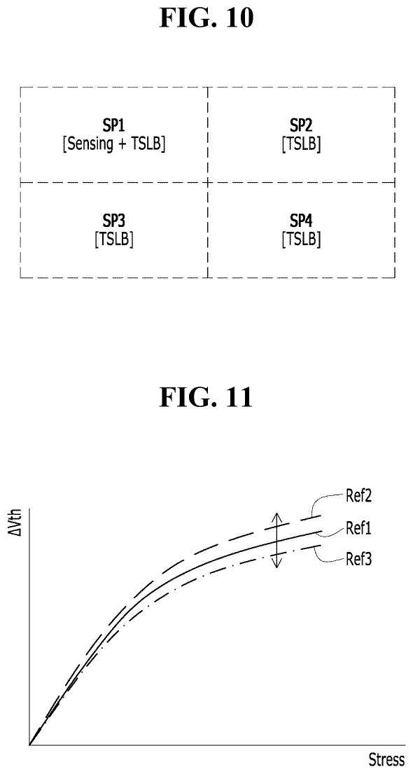

FIG. 9 is an illustrative diagram illustrating pixel groups according to a first embodiment of the present disclosure, and FIGS. 10 and 11 are diagrams for briefly describing a compensation method using subpixels included in a pixel group according to the first embodiment.

Meanwhile, in FIG. 9, (R), (W), (B), and (G) are separately used as reference symbols for subpixels to represent color of light emitted by each subpixel. However, note that this should be interpreted as an example since an arrangement order of subpixels by color is not limited thereto and is diverse.

As illustrated in FIG. 9, the pixel groups according to the first embodiment can include a first pixel group SPG1 to a fourth pixel group SPG4. The first pixel group SPG1 and the second pixel group SPG2 are disposed on the first gate line GL1, and the third pixel group SPG3 and the fourth pixel group SPG4 are disposed on the second gate line GL2 as an example. However, an arrangement order can be reversed.

The first pixel group SPG1 can include first and second subpixels SP1 and SP2 connected to the first and second data lines DL1 to 2 and third and fourth subpixels SP3 and SP4 connected to the third and fourth data lines DL3 to 4. The first to fourth subpixels SP1 to SP4 can be disposed in the order of red subpixel (R), white subpixel (W), blue subpixel (B), and green subpixel (G). All of the first to fourth subpixels SP1 to SP4 can be commonly connected to the first gate line GL1, but only one of the subpixels, the first subpixel SP1, can be connected to the first sensing line REF1. For example, only the first subpixel SP1 can be configured as a compensation subpixel including a sensing transistor ST, and the remaining subpixels SP2 to SP4 can be configured as normal subpixels.

The second pixel group SPG2 can include fifth and sixth subpixels SP5 and SP6 connected to the fifth and sixth data lines DL5 to 6 and seventh and eighth subpixels SP7 and SP8 connected to the seventh and eighth data lines DL7 to 8. The fifth to eighth subpixels SP5 to SP8 can be disposed in the order of red subpixel (R), white subpixel (W), blue subpixel (B), and green subpixel (G). All of the fifth to eighth subpixels SP5 to SP8 can be commonly connected to the first gate line GL1, but only one of the subpixels, the seventh subpixel SP7, can be connected to the second sensing line REF2. For example, only the seventh subpixel SP7 can be configured as a compensation subpixel including a sensing transistor ST, and the remaining subpixels SP5, SP6, and SP8 can be configured as normal subpixels.

The third pixel group SPG3 can include eleventh and twelfth subpixels SP11 and SP12 connected to the first and second data lines DL1 to 2 and thirteenth and fourteenth subpixels SP13 and SP14 connected to the third and fourth data lines DL3 to 4. The eleventh to fourteenth subpixels SP11 to SP14 can be disposed in the order of red subpixel (R), white subpixel (W), blue subpixel (B), and green subpixel (G). All of the eleventh to fourteenth subpixels SP11 to SP14 can be commonly connected to the second gate line GL2, but only one of the subpixels, the twelfth subpixel SP12, can be connected to the first sensing line REF1. For example, only the twelfth subpixel SP12 can be configured as a compensation subpixel including a sensing transistor ST, and the remaining subpixels SP11, SP13, and SP14 can be configured as normal subpixels.

The fourth pixel group SPG4 can include fifteenth and sixteenth subpixels SP15 and SP16 connected to the fifth and sixth data lines DL5 to 6 and seventeenth and eighteenth subpixels SP17 and SP18 connected to the seventh and eighth data lines DL7 to 8. The fifteenth to eighteenth subpixels SP15 to SP18 can be disposed in the order of red subpixel (R), white subpixel (W), blue subpixel (B), and green subpixel (G). All of the fifteenth to eighteenth subpixels SP15 to SP18 can be commonly connected to the second gate line GL2, but only one of the subpixels, the eighteenth subpixel SP18, can be connected to the second sensing line REF2. For example, only the eighteenth subpixel SP18 can be configured as a compensation subpixel including a sensing transistor ST, and the remaining subpixels SP15 to SP17 can be configured as normal subpixels.

Referring to the first pixel group SPG1 to the fourth pixel group SPG4, the first sensing line REF1 and the second sensing line REF2 can have a common feature in that the sensing lines are arranged in a vertical direction (same direction as the data line) to cross a point bisecting the four subpixels in one pixel group. However, referring to subpixels connected to the first sensing line REF1 and the second sensing line REF2 in the first pixel group SPG1 to the fourth pixel group SPG4, the first sensing line REF1 and the second sensing line REF2 can have a difference in that the sensing lines are connected to subpixels emitting different lights of colors in the four pixel groups.

In this way, when subpixels emitting different lights of colors in the four pixel groups are selectively connected to the sensing line, it is possible to sense a compensation subpixel having color representation from the four pixel groups, and compensate for a normal subpixel emitting the same lights of color in the surrounding area based thereon. Further, when such an arrangement and connection structure of these subpixels is used, it is possible to realize advantages in various aspects such as manufacturing, driving, and compensation of the display panel when compared to a method of configuring all subpixels as compensation subpixels.

As illustrated in FIGS. 10 and 11, the subpixels SP1 to SP4 included in the pixel group can compensate for the second to fourth normal subpixels SP2 to SP4 in addition to the first compensation subpixel SP1 based on the sensing value acquired from the first compensation subpixel SP1.

As described above, the second to fourth normal subpixels SP2 to SP4 can compensate for a threshold voltage, etc. of an element included in a subpixel based on a sensing-less compensation algorithm TSLB. Further, the first compensation subpixel SP1 can compensate for a threshold voltage, etc. of an element included in a subpixel based on a sensing value and a sensing-less compensation algorithm (Sensing+TSLB).

The sensing-less compensation algorithm TSLB can compensate for a threshold voltage deviation AVth of an element included in a subpixel in response to accumulated stress. Furthermore, a compensation method based on the sensing value and the sensing-less compensation algorithm (Sensing+TSLB) can correct (reestablish) and update a reference value such as a second reference value Ref2 or a third reference value Ref3 based on an initially defined first reference value Ref1 as well as the sensing value, and an example thereof is as follows.

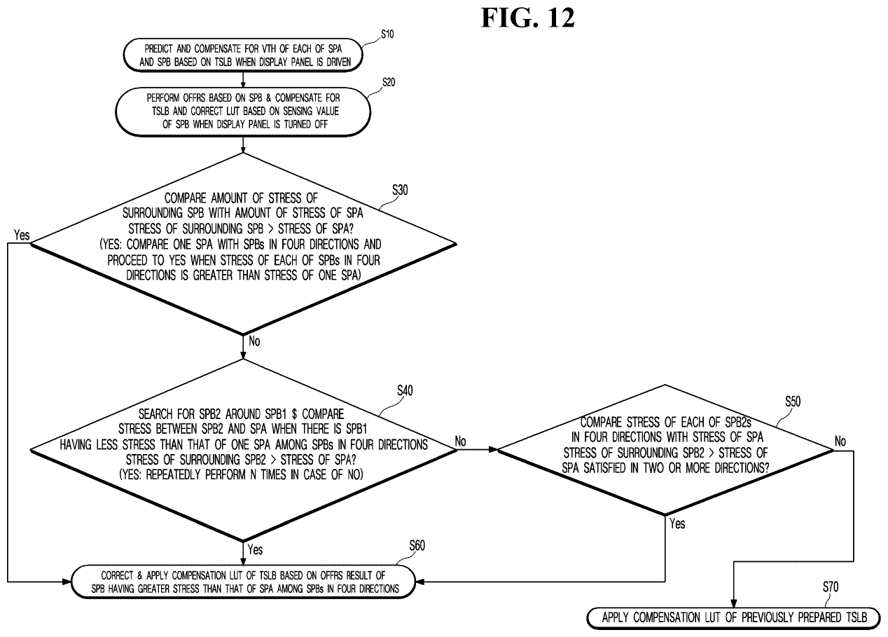

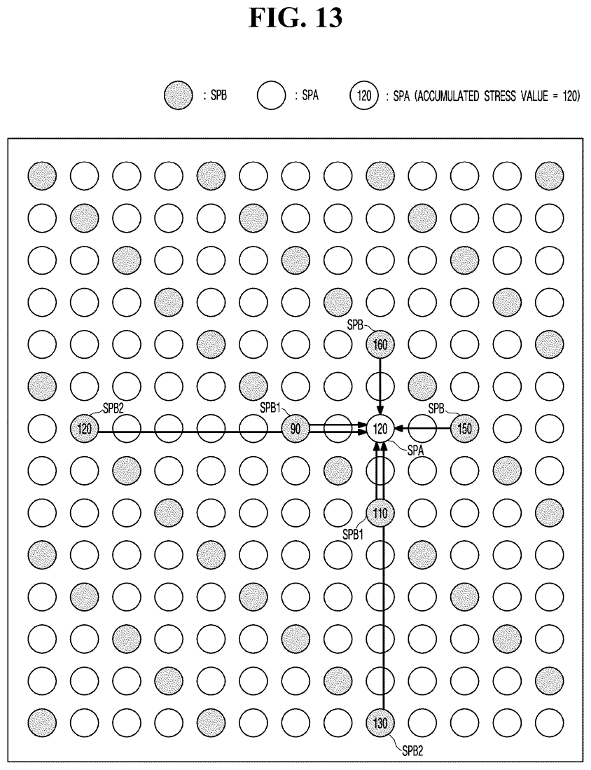

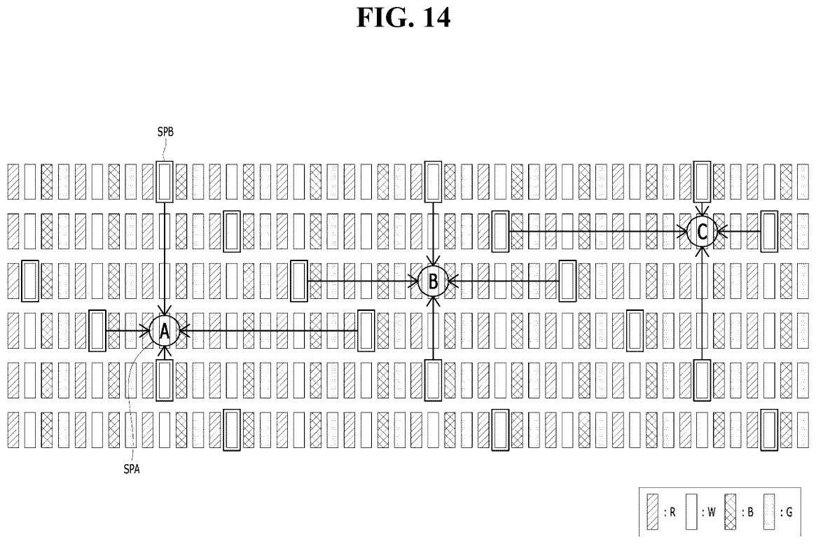

FIG. 12 is a flowchart for describing a compensation method according to the first embodiment, FIG. 13 is a reference diagram illustrating an example of a process of expanding a search range in step S40 according to the first embodiment, and FIG. 14 is a reference diagram illustrating an example in which a sensing value of a compensation subpixel is reflected in a normal subpixel according to the first embodiment.

As illustrated in FIGS. 12 and 13, the compensation method according to the first embodiment can be performed based on a hybrid type including the combination of the normal subpixel SPA and the compensation subpixel SPB.

When the display panel is driven, a threshold voltage Vth of each of the normal subpixel SPA (first subpixel) and the compensation subpixel SPB (second subpixel) can be predicted and compensated in real time based on the sensing-less compensation algorithm TSLB (S10).

When the display panel is turned off, off compensation driving OFFRS can be performed to acquire the sensing value based on the compensation subpixel SPB, and a compensation lookup table LUT of the sensing-less compensation algorithm TSLB can be corrected based on the sensing value acquired from the compensation subpixel SPB (S20). Here, the compensation lookup table LUT of the sensing-less compensation algorithm TSLB for the compensation subpixel SPB can be corrected based on the sensing value. Further, the compensation lookup table of the sensing-less compensation algorithm TSLB for the normal subpixel SPA can be corrected based on a value (applied value) applied to a compensation lookup table of the sensing-less compensation algorithm TSLB for the surrounding compensation subpixel SPB disposed in the surrounding area.

To this end, the amount of accumulated stress can be compared between the normal subpixel SPA and the surrounding compensation subpixel SPB disposed in the surrounding area. Further, it is possible to determine a relationship of accumulated stress of the surrounding compensation subpixel SPB is greater than accumulated stress of the normal subpixel SPA (S30). For example, the amount of accumulated stress can be compared between one normal subpixel SPA and surrounding compensation subpixels SPB disposed around the normal subpixel SPA in four directions (up, down, left, and right). Here, when the amount of accumulated stress of each of the compensation subpixels SPB in the four directions is greater than that of the one normal subpixel SPA, the process can proceed to “YES”. Otherwise, the process can proceed to “NO”.

Next, when the process proceeds to “YES” from the previous step S30, the compensation lookup table LUT of the sensing-less compensation algorithm TSLB can be corrected and applied (corresponding to an example in which deterioration of subpixels is compensated based on TSLB in which LUT is corrected compared to the previous one) based on an off compensation driving OFFRS result of a compensation subpixel SPB having greater amount of accumulated stress than that of the normal subpixel SPA among the compensation subpixels SPB in the four directions (S60).

Meanwhile, when the process proceeds to “NO” from the previous step S30, it is possible to determine whether a first compensation subpixel SPB1 having less accumulated stress than that of the one normal subpixel SPA is present among the compensation subpixels SPB in the four directions. This can be interpreted as a method to exclude a compensation subpixel SPB having less accumulated stress than that of the normal subpixels SPA from compensation reference values and to expand a search range of new compensation subpixels to be used for the compensation reference values.

Therefore, when the first compensation subpixel SPB1 is present, the amount of accumulated stress can be compared between a second compensation subpixel SPB2 adjacent to the first compensation subpixel SPB1 and the normal subpixel SPA. Further, it is possible to determine a relationship of accumulated stress of the second compensation subpixel SPB2 is greater than accumulated stress of the normal subpixel SPA (S40). For example, when the accumulated stress of the second compensation subpixel SPB2 is greater than the accumulated stress of the normal subpixel SPA, this case corresponds to “YES” indicating that a new compensation subpixel to be used for a compensation reference value has been found, and thus the process can proceed to step S60. On the other hand, when the case corresponds to “NO”, the above-described process can be repeatedly performed N times (N being an integer greater than or equal to 1), the search range can be further expanded to find a new compensation subpixel to be used for a compensation reference value, and the process can proceed to step S50.

Meanwhile, when the previous step S40 proceeds to “NO”, accumulated stress of each of the second compensation subpixels SPB2 in the four directions can be compared with accumulated stress of the normal subpixel SPA. Then, a relationship of accumulated stress of the second compensation subpixels SPB2 is greater than accumulated stress of the normal subpixel SPA is determined. When stress of SPB2 is greater than stress of SPA is satisfied in at least two directions, this case corresponds to “YES”, and thus the process can proceed to step S60. On the other hand, when the case corresponds to “NO”, it is possible to apply a compensation lookup table LUT of a previously prepared sensing-less compensation algorithm TSLB (corresponding to an example in which deterioration of subpixels is compensated based on TSLB in which LUT is not corrected compared to the previous one) (S70).

As illustrated in FIG. 14, through the above-described steps, deterioration of the normal subpixel SPA at point A can be compensated based on a sensing value of the compensation subpixel SPB located around point A. Further, deterioration of the normal subpixel SPA at point B can be compensated based on a sensing value of the compensation subpixel SPB located around point B. Further, deterioration of the normal subpixel SPA at point C can be compensated based on a sensing value of the compensation subpixel SPB located around point C.

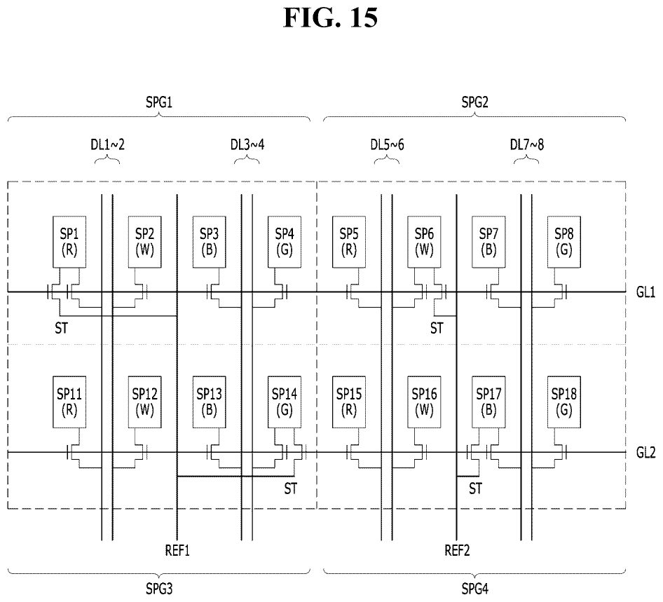

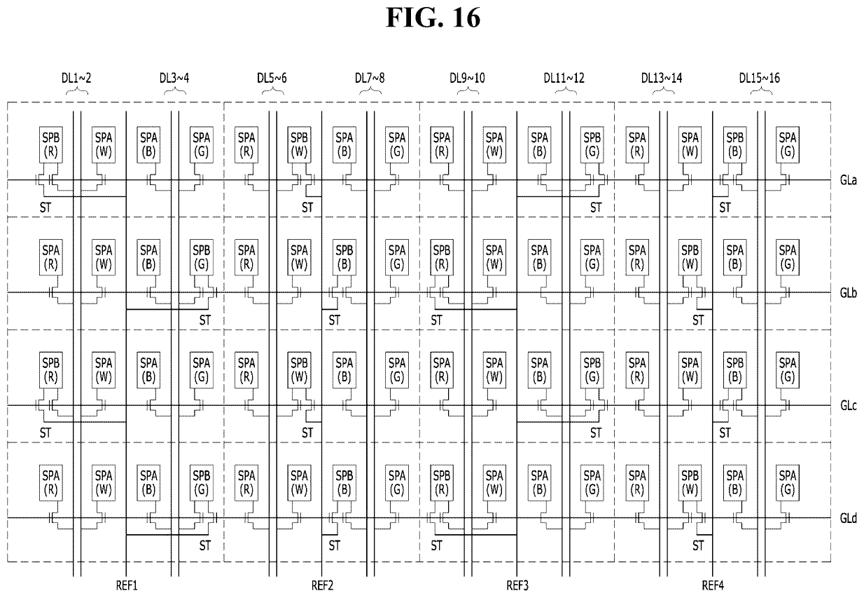

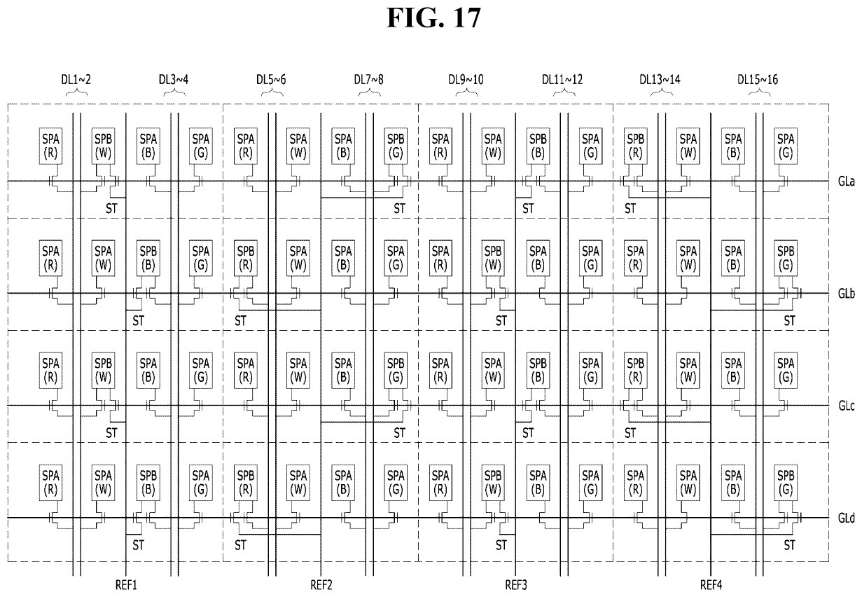

FIG. 15 is an illustrative diagram illustrating pixel groups according to a second embodiment of the present disclosure, FIG. 16 is a first illustrative arrangement diagram of a display panel prepared based on the pixel groups illustrated in FIG. 15, and FIG. 17 is a second illustrative arrangement diagram of a display panel prepared based on the pixel groups illustrated in FIG. 15.

In FIGS. 15 to 17, (R), (W), (B), and (G) are separately used as reference symbols for subpixels to represent color of light emitted by each subpixel. However, note that this should be interpreted as an example since an arrangement order of subpixels by color is not limited thereto and is diverse.

As illustrated in FIG. 15, the pixel groups according to the second embodiment can include a first pixel group SPG1 to a fourth pixel group SPG4. The first pixel group SPG1 and the second pixel group SPG2 are disposed on the first gate line GL1, and the third pixel group SPG3 and the fourth pixel group SPG4 are disposed on the second gate line GL2 as an example. However, the arrangement order can be reversed.

The first pixel group SPG1 can include first and second subpixels SP1 and SP2 connected to the first and second data lines DL1 to 2 and third and fourth subpixels SP3 and SP4 connected to the third and fourth data lines DL3 to 4. The first to fourth subpixels SP1 to SP4 can be disposed in the order of red subpixel (R), white subpixel (W), blue subpixel (B), and green subpixel (G). All of the first to fourth subpixels SP1 to SP4 can be commonly connected to the first gate line GL1, but only one of the subpixels, the first subpixel SP1, can be connected to the first sensing line REF1. For example, only the first subpixel SP1 can be configured as a compensation subpixel including a sensing transistor ST, and the remaining subpixels SP2 to SP4 can be configured as normal subpixels.

The second pixel group SPG2 can include fifth and sixth subpixels SP5 and SP6 connected to the fifth and sixth data lines DL5 to 6 and seventh and eighth subpixels SP7 and SP8 connected to the seventh and eighth data lines DL7 to 8. The fifth to eighth subpixels SP5 to SP8 can be disposed in the order of red subpixel (R), white subpixel (W), blue subpixel (B), and green subpixel (G). All of the fifth to eighth subpixels SP5 to SP8 can be commonly connected to the first gate line GL1, but only one of the subpixels, the sixth subpixel SP6, can be connected to the second sensing line REF2. For example, only the sixth subpixel SP6 can be configured as a compensation subpixel including a sensing transistor ST, and the remaining subpixels SP5, SP7, and SP8 can be configured as normal subpixels.

The third pixel group SPG3 can include eleventh and twelfth subpixels SP11 and SP12 connected to the first and second data lines DL1 to 2 and thirteenth and fourteenth subpixels SP13 and SP14 connected to the third and fourth data lines DL3 to 4. The eleventh to fourteenth subpixels SP11 to SP14 can be disposed in the order of red subpixel (R), white subpixel (W), blue subpixel (B), and green subpixel (G). All of the eleventh to fourteenth subpixels SP11 to SP14 can be commonly connected to the second gate line GL2, but only one of the subpixels, the fourteenth subpixel SP14, can be connected to the first sensing line REF1. For example, only the fourteenth subpixel SP14 can be configured as a compensation subpixel including a sensing transistor ST, and the remaining subpixels SP11, SP12, and SP13 can be configured as normal subpixels.

The fourth pixel group SPG4 can include fifteenth and sixteenth subpixels SP15 and SP16 connected to the fifth and sixth data lines DL5 to 6 and seventeenth and eighteenth subpixels SP17 and SP18 connected to the seventh and eighth data lines DL7 to 8. The fifteenth to eighteenth subpixels SP15 to SP18 can be disposed in the order of red subpixel (R), white subpixel (W), blue subpixel (B), and green subpixel (G). All of the fifteenth to eighteenth subpixels SP15 to SP18 can be commonly connected to the second gate line GL2, but only one of the subpixels, the seventeenth subpixel SP17, can be connected to the second sensing line REF2. For example, only the seventeenth subpixel SP17 can be configured as a compensation subpixel including a sensing transistor ST, and the remaining subpixels SP15, SP16, and SP18 can be configured as normal subpixels.

Referring to the first pixel group SPG1 to the fourth pixel group SPG4, the first sensing line REF1 and the second sensing line REF2 can have a common feature in that the sensing lines are arranged in a vertical direction (same direction as the data line) to cross a point bisecting the four subpixels in one pixel group. However, referring to subpixels connected to the first sensing line REF1 and the second sensing line REF2 in the first pixel group SPG1 to the fourth pixel group SPG4, the first sensing line REF1 and the second sensing line REF2 can have a difference in that the sensing lines are connected to subpixels emitting different lights of colors in the four pixel groups.

As illustrated in FIG. 16, according to a first arrangement example of the second embodiment, the display panel 150 can be prepared based on the pixel groups illustrated in FIG. 15, which is described as follows.

Subpixels separately connected to the first to eighth data lines DL1 to DL8 and the first and second sensing lines REF1 to REF2 in an Ath gate line GLa and a Cth gate line GLc can be prepared based on the first pixel group SPG1 and the second pixel group SPG2 of FIG. 15. Subpixels separately connected to the ninth to sixteenth data lines DL9 to DL16 and the third and fourth gate line GLc can be prepared based on the third pixel group SPG3 and the fourth pixel group SPG4 of FIG. 15.

Subpixels separately connected to the first to eighth data lines DL1 to DL8 and the first and second sensing lines REF1 to REF2 in a Bth gate line GLb and a Dth gate line GLd can be prepared based on the third pixel group SPG3 and the fourth pixel group SPG4 of FIG. 15. Subpixels separately connected to the ninth to sixteenth data lines DL9 to DL16 and the third and fourth sensing lines REF3 to REF4 in the Bth gate line GLb and the Dth gate line GLd can be prepared based on the first pixel group SPG1 and the second pixel group SPG2 of FIG. 15.

As illustrated in FIG. 17, according to a second arrangement example of the second embodiment, the display panel 150 can be prepared based on the pixel groups illustrated in FIG. 15, which is described as follows.

Subpixels separately connected to the first to eighth data lines DL1 to DL8 and the first and second sensing lines REF1 to REF2 in an Ath gate line GLa and a Cth gate line GLc can be prepared based on the second pixel group SPG2 and the third pixel group SPG3 of FIG. 15. Subpixels separately connected to the ninth to sixteenth data lines DL9 to DL16 and the third and fourth gate line GLc can be prepared based on the fourth pixel group SPG4 and the first pixel group SPG1 of FIG. 15.

Subpixels separately connected to the first to eighth data lines DL1 to DL8 and the first and second sensing lines REF1 to REF2 in a Bth gate line GLb and a Dth gate line GLd can be prepared based on the fourth pixel group SPG4 and the first pixel group SPG1 of FIG. 15. Subpixels separately connected to the ninth to sixteenth data lines DL9 to DL16 and the third and fourth sensing lines REF3 to REF4 in the Bth gate line GLb and the Dth gate line GLd can be prepared based on the second pixel group SPG2 and the third pixel group SPG3 of FIG. 15.

Referring to the arrangement examples of FIGS. 16 and 17, pixel groups can be divided into odd-numbered gate line pixel groups disposed on odd-numbered gate lines and even-numbered gate line pixel groups disposed on even-numbered gate lines. Further, compensation subpixels included in each of the odd-numbered gate line pixel groups and the even-numbered gate line pixel groups can be alternately disposed for each gate line on the right and left sides with respect to a sensing line.

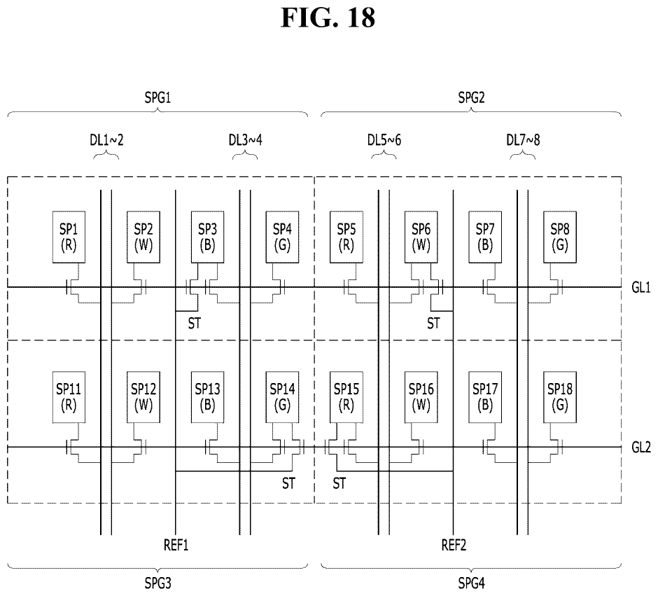

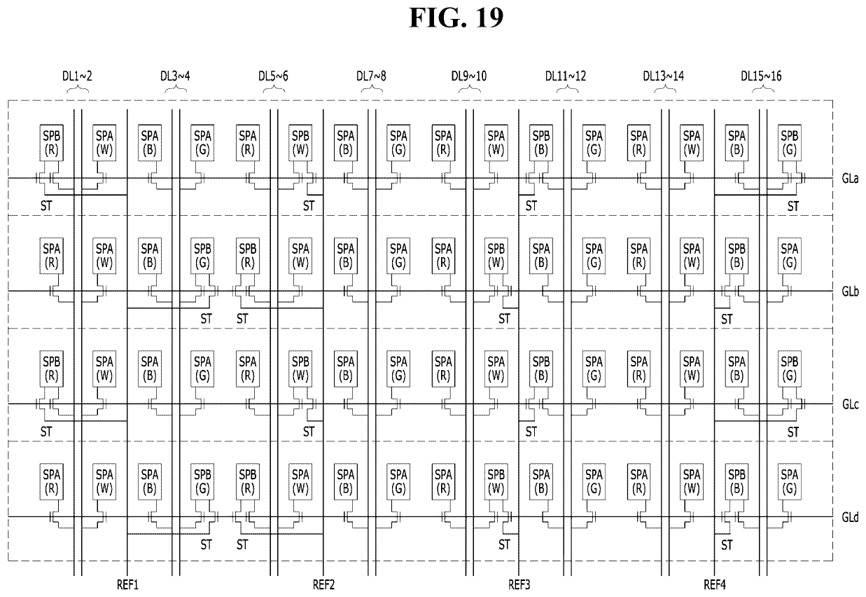

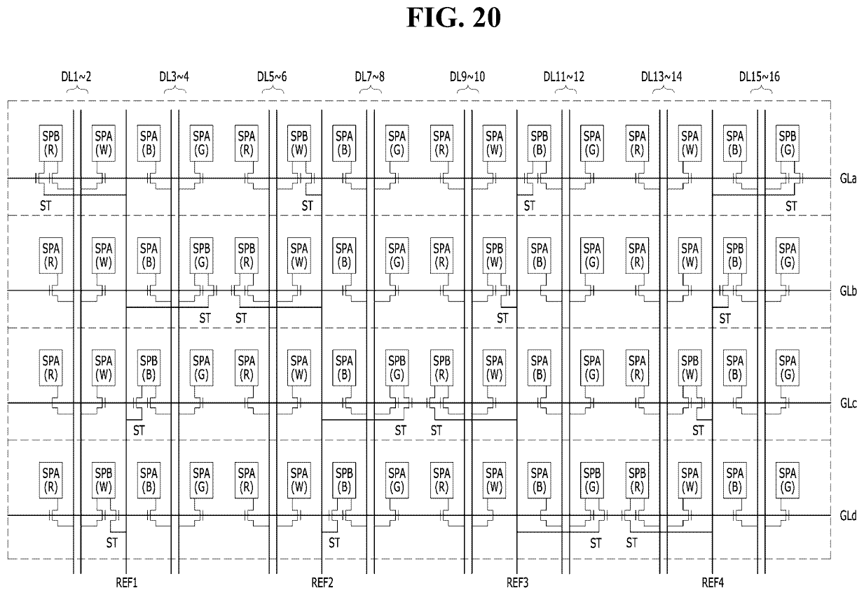

FIG. 18 is an illustrative diagram illustrating pixel groups according to a third embodiment of the present disclosure, FIG. 19 is a first illustrative arrangement diagram of a display panel prepared based on the pixel groups illustrated in FIG. 18, and FIG. 20 is a second illustrative arrangement diagram of a display panel prepared based on the pixel groups illustrated in FIG. 18.

In FIGS. 18 to 20, (R), (W), (B), and (G) are separately used as reference symbols for subpixels to represent color of light emitted by each subpixel. However, note that this should be interpreted as an example since an arrangement order of subpixels by color is not limited thereto and is diverse.

As illustrated in FIG. 18, the pixel groups according to the third embodiment can include a first pixel group SPG1 to a fourth pixel group SPG4. The first pixel group SPG1 and the second pixel group SPG2 are disposed on the first gate line GL1, and the third pixel group SPG3 and the fourth pixel group SPG4 are disposed on the second gate line GL2 as an example. However, an arrangement order can be reversed.

The first pixel group SPG1 can include first and second subpixels SP1 and SP2 connected to the first and second data lines DL1 to 2 and third and fourth subpixels SP3 and SP4 connected to the third and fourth data lines DL3 to 4. The first to fourth subpixels SP1 to SP4 can be disposed in the order of red subpixel (R), white subpixel (W), blue subpixel (B), and green subpixel (G). All of the first to fourth subpixels SP1 to SP4 can be commonly connected to the first gate line GL1, but only one of the subpixels, the third subpixel SP3, can be connected to the first sensing line REF1. For example, only the third subpixel SP3 can be configured as a compensation subpixel including a sensing transistor ST, and the remaining subpixels SP1, SP2 and SP4 can be configured as normal subpixels.

The second pixel group SPG2 can include fifth and sixth subpixels SP5 and SP6 connected to the fifth and sixth data lines DL5 to 6 and seventh and eighth subpixels SP7 and SP8 connected to the seventh and eighth data lines DL7 to 8. The fifth to eighth subpixels SP5 to SP8 can be disposed in the order of red subpixel (R), white subpixel (W), blue subpixel (B), and green subpixel (G). All of the fifth to eighth subpixels SP5 to SP8 can be commonly connected to the first gate line GL1, but only one of the subpixels, the sixth subpixel SP6, can be connected to the second sensing line REF2. For example, only the sixth subpixel SP6 can be configured as a compensation subpixel including a sensing transistor ST, and the remaining subpixels SP5, SP7, and SP8 can be configured as normal subpixels.

The third pixel group SPG3 can include eleventh and twelfth subpixels SP11 and SP12 connected to the first and second data lines DL1 to 2 and thirteenth and fourteenth subpixels SP13 and SP14 connected to the third and fourth data lines DL3 to 4. The eleventh to fourteenth subpixels SP11 to SP14 can be disposed in the order of red subpixel (R), white subpixel (W), blue subpixel (B), and green subpixel (G). All of the eleventh to fourteenth subpixels SP11 to SP14 can be commonly connected to the second gate line GL2, but only one of the subpixels, the fourteenth subpixel SP14, can be connected to the first sensing line REF1. For example, only the fourteenth subpixel SP14 can be configured as a compensation subpixel including a sensing transistor ST, and the remaining subpixels SP11, SP12, and SP13 can be configured as normal subpixels.

The fourth pixel group SPG4 can include fifteenth and sixteenth subpixels SP15 and SP16 connected to the fifth and sixth data lines DL5 to 6 and seventeenth and eighteenth subpixels SP17 and SP18 connected to the seventh and eighth data lines DL7 to 8. The fifteenth to eighteenth subpixels SP15 to SP18 can be disposed in the order of red subpixel (R), white subpixel (W), blue subpixel (B), and green subpixel (G). All of the fifteenth to eighteenth subpixels SP15 to SP18 can be commonly connected to the second gate line GL2, but only one of the subpixels, the fifteenth subpixel SP15, can be connected to the second sensing line REF2. For example, only the fifteenth subpixel SP15 can be configured as a compensation subpixel including a sensing transistor ST, and the remaining subpixels SP16, SP17, and SP18 can be configured as normal subpixels.

Referring to the first pixel group SPG1 to the fourth pixel group SPG4, the first sensing line REF1 and the second sensing line REF2 can have a common feature in that the sensing lines are arranged in a vertical direction (same direction as the data line) to cross a point bisecting the four subpixels in one pixel group. However, referring to subpixels connected to the first sensing line REF1 and the second sensing line REF2 in the first pixel group SPG1 to the fourth pixel group SPG4, the first sensing line REF1 and the second sensing line REF2 can have a difference in that the sensing lines are connected to subpixels emitting different lights of colors in the four pixel groups.

As illustrated in FIG. 19, according to a first arrangement example of the third embodiment, the display panel 150 can be prepared based on the pixel groups illustrated in FIG. 18, which is described as follows.

Subpixels separately connected to the first to eighth data lines DL1 to DL8 and the first and second sensing lines REF1 to REF2 in an Ath gate line GLa and a Cth gate line GLc can be prepared based on the first pixel group SPG1 and the second pixel group SPG2 of FIG. 18. Subpixels separately connected to the ninth to sixteenth data lines DL9 to DL16 and the third and fourth gate line GLc can be prepared based on the first pixel group SPG1 and the third pixel group SPG3 of FIG. 18.

Subpixels separately connected to the first to eighth data lines DL1 to DL8 and the first and second sensing lines REF1 to REF2 in a Bth gate line GLb and a Dth gate line GLd can be prepared based on the third pixel group SPG3 and the fourth pixel group SPG4 of FIG. 18. Subpixels separately connected to the ninth to sixteenth data lines DL9 to DL16 and the third and fourth sensing lines REF3 to REF4 in the Bth gate line GLb and the Dth gate line GLd can be prepared based on the second pixel group SPG2 and the first pixel group SPG1 of FIG. 18.

Referring to the arrangement example of FIG. 19, pixel groups can be divided into odd-numbered gate line pixel groups disposed on odd-numbered gate lines and even-numbered gate line pixel groups disposed on even-numbered gate lines. Further, compensation subpixels included in each of the odd-numbered gate line pixel groups and the even-numbered gate line pixel groups can be divided into an alternating group in which the compensation subpixels are alternately disposed for each gate line on the right and left sides with respect to a sensing line and a non-alternating group in which the compensation subpixels are continuously disposed for every at least two gate lines on the right and left sides with respect to the sensing line.

As illustrated in FIG. 20, according to a third arrangement example of the third embodiment, the display panel 150 can be prepared based on the pixel groups illustrated in FIG. 18, which is described as follows.

Subpixels separately connected to the first to eighth data lines DL1 to DL8 and the first and second sensing lines REF1 to REF2 in an Ath gate line GLa can be prepared based on the fourth pixel group SPG4 and the second pixel group SPG2 of FIG. 18. Subpixels separately connected to the ninth to sixteenth data lines DL9 to DL16 and the third and fourth sensing lines REF3 to REF4 in the Ath gate line GLa can be prepared based on the first pixel group SPG1 and the third pixel group SPG3 of FIG. 18.

Subpixels separately connected to the first to eighth data lines DL1 to DL8 and the first and second sensing lines REF1 to REF2 in a Bth gate line GLb can be prepared based on the third pixel group SPG3 and the fourth pixel group SPG4 of FIG. 18. Subpixels separately connected to the ninth to sixteenth data lines DL9 to DL16 and the third and fourth sensing lines REF3 to REF4 in the Bth gate line GLb can be prepared based on the second pixel group SPG2 and the first pixel group SPG1 of FIG. 18.

Subpixels separately connected to the first to eighth data lines DL1 to DL8 and the first and second sensing lines REF1 to REF2 in a Cth gate line GLc can be prepared based on the first pixel group SPG1 and the third pixel group SPG3 of FIG. 18. Subpixels separately connected to the ninth to sixteenth data lines DL9 to DL16 and the third and fourth sensing lines REF3 to REF4 in the Cth gate line GLc can be prepared based on the fourth pixel group SPG4 and the second pixel group SPG2 of FIG. 18.

Subpixels separately connected to the first to eighth data lines DL1 to DL8 and the first and second sensing lines REF1 to REF2 in a Dth gate line GLd can be prepared based on the second pixel group SPG2 and the first pixel group SPG1 of FIG. 18. Subpixels separately connected to the ninth to sixteenth data lines DL9 to DL16 and the third and fourth sensing lines REF3 to REF4 in the Dth gate line GLd can be prepared based on the third pixel group SPG3 and the fourth pixel group SPG4 of FIG. 18.

Referring to the arrangement example of FIG. 20, pixel groups can be divided into at least four gate line pixel groups having different compensation subpixel arrangement structures for each gate line. Further, compensation subpixels included in each of the at least four gate line pixel groups can be divided into an alternating group in which the compensation subpixels are alternately disposed for each gate line on the right and left sides with respect to a sensing line and a non-alternating group in which the compensation subpixels are continuously disposed for every at least two gate lines on the right and left sides with respect to the sensing line.

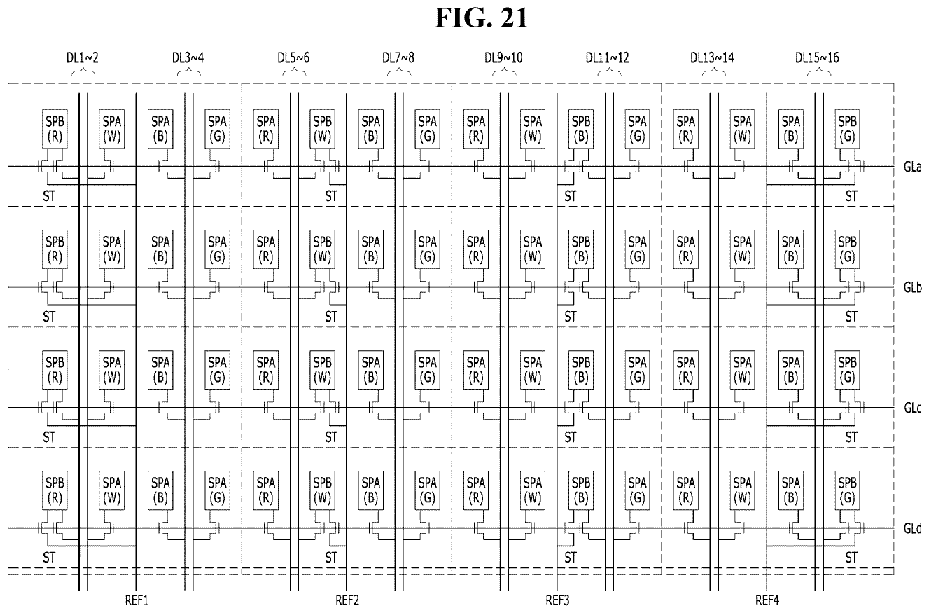

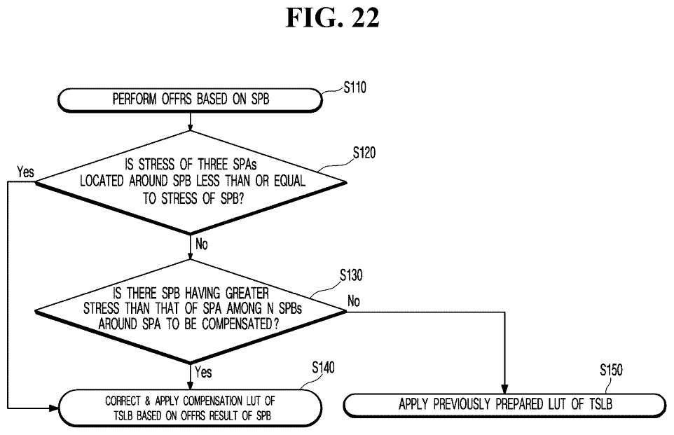

FIG. 21 is an illustrative arrangement diagram of a display panel prepared based on pixel groups according to a fourth embodiment of the present disclosure, and FIG. 22 is a flowchart for describing a compensation method according to the fourth embodiment.

As illustrated in FIG. 21, according to an arrangement example of the fourth embodiment, the display panel 150 can be based on the pixel groups illustrated in FIG. 15, and some pixel groups can be provided with different connection structures, which will be described as follows.

Subpixels separately connected to the first to eighth data lines DL1 to DL8 and the first and second sensing lines REF1 to REF2 in an Ath gate line GLa to a Dth gate line GLd can be prepared based on the first pixel group SPG1 and the second pixel group SPG2 of FIG. 15. Subpixels separately connected to the ninth to sixteenth data lines DL9 to DL16 and the third and fourth sensing lines REF3 to REF4 in the Ath gate line GLa and the Cth gate line GLc can be prepared to be symmetrical to the first pixel group SPG1 and the second pixel group SPG2 of FIG. 15.

Referring to the arrangement example of FIG. 21, pixel groups can be divided into one-side (left) pixel groups and the other-side (right) pixel groups so that the pixel groups are left and right symmetrical with respect to a specific data line. In addition, compensation subpixels included in each of the one-side pixel groups and the other-pixel groups which are left and right symmetrical can be disposed in a straight line based on the sensing line to be consistent along the vertical direction without alternating for each gate line.

As illustrated in FIG. 22, the compensation method according to the fourth embodiment can be performed based on a hybrid type including the combination of the normal subpixel SPA and the compensation subpixel SPB.

When the display panel is turned off, off compensation driving OFFRS can be performed to acquire a sensing value based on the compensation subpixel SPB (S110). Based on the sensing value acquired through off compensation driving OFFRS, it is possible to determine whether the amount of accumulated stress of three normal subpixels SPA located around the compensation subpixel SPB is less than or equal to the amount of accumulated stress of the compensation subpixel SPB (S120).

Here, when the amount of accumulated stress of the three normal subpixels SPA is less than or equal to the amount of accumulated stress of the compensation subpixel SPB, the process can proceed to “YES”. Otherwise, the process can proceed to “NO”.

On the other hand, when the process proceeds to “NO” in the previous step S120, it is possible to determine whether there is a compensation subpixel SPB having a greater amount of stress than that of the normal subpixel SPA among N compensation subpixels SPB (N being an integer greater than or equal to 1) around the normal subpixel SPA to be compensated (S130).

Next, when the process proceeds to “YES” in the previous steps S120 and S130, the compensation lookup table LUT of the sensing-less compensation algorithm TSLB can be corrected and applied (corresponding to an example in which deterioration of subpixels is compensated based on TSLB in which previous LUT is corrected) based on an off compensation driving OFFRS result of the compensation subpixel SPB (S140).

On the other hand, when the process proceeds to “NO” in the previous step S130, a previously prepared compensation lookup table LUT of the sensing-less compensation algorithm TSLB can be applied (corresponding to an example in which deterioration of subpixels is compensated based on TSLB in which previous LUT is not corrected) (S150).

Meanwhile, the compensation method according to the fourth embodiment can be applied not only to the display panel having the arrangement structure of FIG. 21 but also to the display panels having the arrangement structures described in the first to third embodiments described above.

Referring to the first to fourth embodiments of the present disclosure, the pixel groups can include at least four pixel groups each including compensation subpixels emitting different lights of colors. In addition, the at least four pixel groups can all be disposed on one gate line defined in the display panel, or can be disposed one by one for each gate line defined in the display panel.

In addition, the at least four pixel groups are all disposed on one gate line. However, the pixel groups can be sequentially disposed from the first pixel group to the fourth pixel group, and can be disposed reverse sequentially or non-sequentially (randomly).

In addition, in the first to fourth embodiments, the first to fourth pixel groups are disposed adjacent to each other left and right or top and bottom as an example. However, a pixel group including only normal subpixels can be located between the left and right or top and bottom of the first to fourth pixel groups. For example, the display panel can be implemented as a hybrid pixel group including a normal subpixel and a compensation subpixel, as well as a normal pixel group including only normal subpixels.

As described above, the present disclosure has an effect of being able to improve correction accuracy and compensation performance by compensating for a normal subpixel emitting the same lights of color in the surrounding area based on a sensing value and accumulated stress (in other words, usage) and correcting (reestablishing) and updating a sensing-less compensation algorithm based on a sensing value of a compensation subpixel. In addition, the present disclosure has an effect of being able to manifest advantages in various aspects such as implementation, production, operation, and compensation of the display panel by sensing a compensation subpixel having representativeness for each color, and compensating for a normal subpixel emitting the same lights of color in the surrounding area based thereon.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A display device comprising:
a display panel comprising pixel groups configured to emit light to display an image;
a data driver configured to drive the display panel; and
a timing controller configured to control the data driver, wherein:
at least one of the pixel groups comprises a normal subpixel connected to a data line and a compensation subpixel connected to the data line and a sensing line, and
the normal subpixel and the compensation subpixel emit light of different colors.

2. The display device according to claim 1, wherein the pixel groups comprise at least four pixel groups each including a compensation subpixel configured to emit a different color.

3. The display device according to claim 2, wherein the at least four pixel groups are all disposed on one gate line defined in the display panel or are disposed one by one for each gate line defined in the display panel.

4. The display device according to claim 2, wherein the at least four pixel groups comprise:
a first pixel group comprising a first compensation subpixel configured to emit a first color;
a second pixel group comprising a second compensation subpixel configured to emit a second color different from the first color;
a third pixel group comprising a third compensation subpixel configured to emit a third color different from the second color; and
a fourth pixel group comprising a fourth compensation subpixel configured to emit a fourth color different from the third color.

5. The display device according to claim 4, wherein:
the first pixel group comprises:
a first subpixel connected to a first data line and a first sensing line;
a second subpixel connected to a second data line adjacent to the first data line;
a third subpixel connected to a third data line spaced apart from the second data line; and
a fourth subpixel connected to a fourth data line adjacent to the third data line, and
the second pixel group comprises:
a fifth subpixel connected to a fifth data line;
a sixth subpixel connected to a sixth data line adjacent to the fifth data line;
a seventh subpixel connected to a seventh data line spaced apart from the sixth data line and a second sensing line; and
an eighth subpixel connected to an eighth data line adjacent to the seventh data line.

6. The display device according to claim 1, wherein:
the data driver provides a sensing value acquired from the compensation subpixel to the timing controller, and the timing controller compensates for deterioration of at least one of the normal subpixel or the compensation subpixel based on the sensing value provided from the data driver.

7. The display device according to claim 6, wherein the timing controller corrects a lookup table of a compensation algorithm prepared to compensate for the deterioration of the at least one of the normal subpixel or the compensation subpixel based on the sensing value.

8. The display device according to claim 6, wherein the timing controller corrects the lookup table of the compensation algorithm prepared to compensate for deterioration of the normal subpixel based on a value applied to a compensation lookup table of the sensing-less compensation algorithm for the surrounding compensation subpixel disposed in the surrounding area of the normal subpixel.

9. The display device according to claim 8, wherein the display device is configured to perform the correction based on an off compensation driving result of a target compensation subpixel having greater amount of accumulated stress than that of the normal subpixel among the compensation subpixels disposed in the surrounding area.

10. The display device according to claim 9, wherein the display device is configured to expand the search range for the surrounding compensation subpixels and re-search when the target compensation subpixel is not found in the surrounding compensation subpixels.

11. A display device comprising:
a display panel comprising at least four pixel groups each including one compensation subpixel configured to emit light of a different color;
a data driver configured to drive the display panel and sense each of the at least four pixel groups to acquire each of color-specific sensing values having color representativeness from the compensation subpixel; and
a timing controller configured to control the data driver and compensate for data signals to be supplied to normal subpixels included in the at least four pixel groups based on the color-specific sensing values.

12. The display device according to claim 11, wherein the timing controller compensates for a normal subpixel configured to emit light of the same color as the color of the compensation subpixel based on the color-specific sensing values.

13. The display device according to claim 11, wherein the at least four pixel groups comprise:
a first pixel group comprising a first compensation subpixel configured to emit light of a first color and three normal subpixels;
a second pixel group comprising a second compensation subpixel configured to emit light of a second color different from the first color and three normal subpixels;
a third pixel group comprising a third compensation subpixel configured to emit light of a third color different from the second color and three normal subpixels; and
a fourth pixel group comprising a fourth compensation subpixel configured to emit light of a fourth color different from the third color and three normal subpixels.

14. A method of driving a display device, the method comprising:
driving at least four pixel groups each comprising one compensation subpixel configured to emit light of a different color;
sensing each of the at least four pixel groups to acquire each of color-specific sensing values having color representativeness from the compensation subpixel; and
compensating for data signals to be supplied to normal subpixels included in the at least four pixel groups based on the color-specific sensing values.

15. The method according to claim 14, wherein the compensating comprises compensating for a normal subpixel configured to emit the same color of the color of the compensation subpixel based on the color-specific sensing values.
